(19) United States
(12) Patent Application Publication
(10) Pub. No.: US 2026/0185878 A1
(43) Pub. Date: Jul. 2, 2026

(54) FILMS AND DEVICES FOR PHOTON UPCONVERSION OF INFRARED LIGHT

(71) Applicants: Regents of the University of Minnesota, Minneapolis, MN (US); Massachusetts Institute of Technology, Cambridge, MA (US)

(72) Inventors: Sang-Hyun Oh, Plymouth, MN (US); Daehan Yoo, Mountain View, CA (US); Keith A. Nelson, Newton, MA (US); Jiaojian Shi, Palo Alto, CA (US)

(21) Appl. No.: 19/126,155

(22) PCT Filed: Nov. 2, 2023
(86) PCT No.: PCT/US2023/078514

§ 371 Date: Apr. 30, 2025

Related U.S. Application Data
(60) Provisional application No. 63/382,051, filed on Nov. 2, 2022.

(51) Int. Cl. G01J 5/20

(52) U.S. Cl. CPC G01J 5/20

(57) ABSTRACT

An upconversion film or device includes a dielectric layer, a gap electrode layer overlying the dielectric layer, and an upconversion material configured to upconvert infrared light to visible light. The gap electrode layer includes an array of discrete apertures between an array of discrete electrodes and a continuous electrode. Each discrete aperture is defined by a capacitive gap at least partially filled by the upconversion material, An example upconversion film includes capacitive gaps that are each less than nanometers. An example upconversion device includes an optically transparent electrode layer underlying the dielectric layer. An example infrared camera includes an imaging layer that includes an array of sensing elements, in which each discrete aperture is aligned with a sensing element. An example method of manufacturing an upconversion film includes forming a passivation layer on the array of discrete electrodes using atomic layer deposition to form the capacitive gap.

This application is a PCT application claiming priority to U.S. Provisional Patent Application No. 63/382,051, filed Nov. 2, 2022, the entire contents of which is incorporated herein by reference.

### TECHNICAL FIELD

The present disclosure relates to upconversion films and devices.

### BACKGROUND

High-performance infrared thermal cameras may be used for a variety of applications such as COVID-19 temperature checks, night vision, autonomous driving, machine vision, security, missile tracking, and motion-sensing infrared cameras in game consoles. Conventional technologies for infrared detection typically operate at low temperatures using bulky cooling system, have relatively large pixel sizes, are fabricated using a complex and expensive micro-electrical-mechanical system (MEMS) fabrication process, or include toxic materials (e.g., HgCdTe).

### SUMMARY

This disclosure describes upconversion films or devices, and corresponding methods of manufacture and operation, for upconverting infrared light to visible light. An upconversion film includes a gap electrode layer overlying a dielectric layer. The gap electrode layer includes an array of discrete apertures that each form a capacitive gap between two electrodes. An upconversion material that upconverts infrared light to visible light is positioned in a portion of each capacitive gap, thereby confining both an optical field and the optically responsive upconversion material into the capacitive gap. During operation, an electric field generated across the capacitive gap induces an electric field-driven charge transfer in the upconversion material to upconvert infrared light received by the array of discrete apertures into visible light. The capacitive gap may be relatively small, such as sub-wavelength scale for long-wavelength infrared (LWIR) light (typically wavelengths from 8 to 15 micrometers (μm)), resulting in an enhanced electric field in the capacitive gap. The upconversion film may be optically coupled to an array of photodiodes, a CMOS image sensor chip, or a charge-coupled device (CCD) imager to detect the visible light. In this way, upconversion films may enable upconversion devices, such as high-performance LWIR cameras, that may operate at room temperature without cooling, produce a high resolution with a small pixel size and high sensitivity by using conventional CMOS or CCD imager chip, operate using low power and with a small footprint, and be fabricated at a low price.

In one example, an upconversion film includes a dielectric layer, a gap electrode layer overlying the dielectric layer, and an upconversion material. The gap electrode layer includes an array of discrete apertures between an array of discrete electrodes and a continuous layer. The discrete aperture of each discrete electrode of the array of discrete electrodes is defined by a capacitive gap, in which the capacitive gap is less than about one micrometer (μm). The upconversion material—nanoscale luminophores—fills in at least a portion of the capacitive gap, and is configured to upconvert infrared light to visible light.

In one example, an upconversion device includes an optically transparent electrode layer, a dielectric layer overlying the optically transparent electrode layer, a gap electrode layer overlying the dielectric layer, a passivation layer, and an upconversion material. The optically transparent electrode layer includes an optically transparent conductive material. The gap electrode layer includes an array of discrete apertures between an array of discrete electrodes and a continuous layer, and in which each discrete aperture of the array of discrete electrodes is defined by a capacitive gap. The passivation layer is positioned between the continuous layer of the gap electrode layer and the dielectric layer. The upconversion material fills in at least a portion of each capacitive gap, and is configured to upconvert infrared light to visible light.

In one example, an infrared camara includes an imaging layer, an optically transparent electrode layer overlying the imaging layer, a dielectric layer overlying the optically transparent electrode layer, a gap electrode layer overlying the dielectric layer, and an upconversion material. The imaging layer includes an array of sensing elements, such as photosites or photodiodes. The optically transparent electrode layer includes an optically transparent conductive material. The gap electrode layer includes an array of discrete apertures between an array of discrete electrodes and a continuous layer, in which ach discrete aperture of the array of discrete electrodes is defined by a capacitive gap, and each discrete aperture of the array of discrete apertures is aligned with a sensing element of the array of sensing elements. The upconversion material fills in at least a portion of each capacitive gap, and is configured to upconvert infrared light to visible light.

In one example, a method of manufacturing an upconversion film includes forming an array of discrete electrodes on a dielectric layer and forming a passivation layer on the array of discrete electrodes and an exposed portion of the dielectric layer. The passivation layer is formed using a method that produces a thin passivation layer, such as atomic layer deposition. The method further includes forming a continuous layer on the passivation layer to form an array of discrete apertures between the array of discrete electrodes and the continuous layer, in which each discrete aperture of the array of discrete electrodes is defined by a capacitive gap. The method includes removing at least a portion of the passivation layer in each capacitive gap and depositing an upconversion material in at least the portion of each capacitive gap. The upconversion material is configured to upconvert infrared light to visible light.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1A is a perspective view conceptual and schematic diagram illustrating an example upconversion device for upconverting infrared light to visible light.

FIG. 1B is a side view cross-sectional conceptual and schematic diagram illustrating the example upconversion device of FIG. 1A.

FIG. 1C is an exemplary graph of an intensity signal versus electric field strength.

FIG. 2A is a perspective view conceptual and schematic diagram illustrating an example upconversion portion of an infrared camera for upconverting infrared light to visible light.

FIG. 2B is a side view cross-sectional conceptual and schematic diagram illustrating the example upconversion portion of the infrared camera of FIG. 2A.

FIG. 2C is a side view block diagram illustrating an example infrared camera of FIG. 2A.

FIG. 2D is a perspective view conceptual and schematic diagram illustrating an example system for upconverting infrared light to visible light.

FIG. 2E is a side view block diagram illustrating an example infrared camera of FIG. 2A.

FIG. 2F is a diagram illustrating an example system for digitally imaging infrared light.

FIG. 2G is a side view block diagram illustrating an example optical imaging device.

FIG. 2H is a diagram illustrating an example system for optically imaging infrared light.

FIG. 3A is a side view cross-sectional conceptual and schematic diagram illustrating an example deposition of a discrete electrode on a substrate.

FIG. 3B is a side view cross-sectional conceptual and schematic diagram illustrating an example deposition of a passivation layer on the discrete electrode of FIG. 3A.

FIG. 3C is a side view cross-sectional conceptual and schematic diagram illustrating an example deposition of a conductive layer on the passivation layer of FIG. 3B.

FIG. 3D is a side view cross-sectional conceptual and schematic diagram illustrating an example planarization operation of a surface portion of the conductive layer and the passivation layer of FIG. 3C.

FIG. 3B is a side view cross-sectional conceptual and schematic diagram illustrating an example removal of a portion of the passivation layer of FIG. 3D.

FIG. 3F is a side view cross-sectional conceptual and schematic diagram illustrating an example deposition of an upconversion material in a capacitive gap between the conductive layer and the discrete electrode of FIG. 3E.

FIG. 4 is a flow diagram illustrating an example technique for manufacturing an upconversion film for upconverting infrared light to visible light.

FIG. 5A is a side view cross-sectional conceptual and schematic diagram illustrating an example deposition of a discrete electrode on a substrate.

FIG. 5B is a side view cross-sectional conceptual and schematic diagram illustrating an example deposition of an upconversion material on the discrete electrode of FIG. 5A.

FIG. 5C is a side view cross-sectional conceptual and schematic diagram illustrating an example deposition of a conductive layer on the upconversion material of FIG. 5B.

FIG. 5D is a side view cross-sectional conceptual and schematic diagram illustrating an example planarization operation of a surface portion of the conductive layer and the upconversion material of FIG. 5C.

FIG. 6 is a flow diagram illustrating an example technique for manufacturing an upconversion film for upconverting infrared light to visible light.

FIG. 7A is a side view cross-sectional conceptual and schematic diagram illustrating an example deposition of a dielectric layer on a substrate.

FIG. 7B is a side view cross-sectional conceptual and schematic diagram illustrating an example formation of a hole for a via in the dielectric layer of FIG. 7A.

FIG. 7C is a side view cross-sectional conceptual and schematic diagram illustrating an example deposition of a pattern layer on the dielectric layer of FIG. 7B.

FIG. 7D is a side view cross-sectional conceptual and schematic diagram illustrating an example deposition of a discrete electrode on the dielectric layer of FIG. 7C.

FIG. 7E is a side view cross-sectional conceptual and schematic diagram illustrating an example removal of the pattern layer from the dielectric layer of FIG. 7D.

FIG. 7F is a side view cross-sectional conceptual and schematic diagram illustrating an example deposition of a passivation layer on the discrete electrode of FIG. 7E.

FIG. 7G is a side view cross-sectional conceptual and schematic diagram illustrating an example deposition of a conductive layer on the passivation layer of FIG. 7F.

FIG. 7H is a side view cross-sectional conceptual and schematic diagram illustrating an example planarization operation of a surface portion of the conductive layer and the passivation layer of FIG. 7G.

FIG. 7I is a side view cross-sectional conceptual and schematic diagram illustrating an example removal of a portion of the passivation layer of FIG. 7H.

FIG. 7J is a side view cross-sectional conceptual and schematic diagram illustrating an example deposition of an upconversion material in a capacitive gap between the conductive layer and the discrete electrode of FIG. 7I.

FIG. 8 is a flow diagram illustrating an example technique for manufacturing an upconversion film for upconverting infrared light to visible light.

FIG. 9A is a side view cross-sectional conceptual and schematic diagram illustrating an example deposition of a dielectric layer on a substrate.

FIG. 9B is a side view cross-sectional conceptual and schematic diagram illustrating an example formation of a hole for a via in the dielectric layer of FIG. 9A.

FIG. 9C is a side view cross-section conceptual and schematic diagram illustrating an example deposition of a conductive layer on the dielectric layer of FIG. 9B.

FIG. 9D is a side view cross-sectional conceptual and schematic diagram illustrating an example deposition of a pattern layer on the conductive layer of FIG. 9C.

FIG. 9E is a side view cross-sectional conceptual and schematic diagram illustrating an example removal of a portion of the conductive layer of FIG. 9D.

FIG. 9F is a side view cross-sectional conceptual and schematic diagram illustrating an example removal of the pattern layer from the conductive layer of FIG. 9E.

FIG. 9G is a side view cross-sectional conceptual and schematic diagram illustrating an example deposition of an upconversion material in a capacitive gap between the continuous electrode and the discrete electrode of FIG. 9F.

FIG. 10 is a flow diagram illustrating an example technique for manufacturing an upconversion film for upconverting infrared light to visible light.

FIG. 11A is a top view schematic diagram of horizontal distribution of an electric field enhancement factor (E/E₀) through a capacitive gap of an aperture.

FIG. 11B is a cross-sectional side view schematic diagram of vertical distribution of an electric field enhancement factor (E/E₀) through a capacitive gap of an aperture.

FIG. 11C is a graph of transmittance versus wavenumber for different diameters of apertures using finite element method (FEM) modeling.

FIG. 11D is a graph of transmittance versus wavenumber for different diameters of apertures using Fourier transform infrared (FTIR) spectroscopy.

FIG. 12A is an SEM image of an array of apertures having a 10 nm capacitive gap and 440 nm diameter.

FIG. 12B is an SEM image of an array of apertures having a 10 nm capacitive gap and 520 nm diameter.

FIG. 12C is an SEM image of an array of apertures having a 10 nm capacitive gap and 610 nm diameter.

FIG. 12D is an SEM image of an array of apertures having a 10 nm capacitive gap and 710 nm diameter.

FIG. 13A is a graph of spectral radiance of black body radiation for various temperatures of objects.

FIG. 13B is a graph of LWIR electroluminescence versus electric field strength for a 100 nm and a 1 μm capacitive gap.

FIG. 14 is a graph of transmittance and electric field enhancement through an upconversion film versus wavelength using finite-difference time domain (FDTD) simulation.

### DETAILED DESCRIPTION

This disclosure describes upconversion films and devices, and corresponding methods of manufacture and operation, for converting infrared (IR) light to visible light, such as for use in a high-resolution infrared camera. Photon upconversion processes, in which low-energy light is converted to high-energy light, may be used in a variety of applications including light-emitting devices, solar cells, and biomedical imaging. However, the conversion efficiency and working frequency of photon upconversion processes may depend on materials properties, which may significantly limit design of devices and wavelength ranges for which devices may operate. Conventional upconversion processes generally occur within two frequency bands: mid-infrared (MIR) to near-IR (NIR) and NIR to visible. Frequency bands that include lower-energy electromagnetic waves such as LWIR or terahertz (THz) waves may not be readily converted into visible light using these conventional upconversion processes.

In particular, LWIR light may be relatively difficult to upconvert using conventional upconversion mechanisms. Radiation in the THz field may be particularly efficient in driving charge transfer between luminescent sites, as the THz field has a very slow-varying electric field. For example, the THz field may drive a charge for about 1 picosecond (ps) with the same polarity as the charge transfer. However, LWIR light may have a relatively fast oscillating electric field with polarity periodically changing. As a result, radiation in the LWIR field may only accelerate charges for a relatively short period of time compared to the THz field, such as about 10-20 femtosecond (fs), before the field switches polarity, decelerates, and moves the charges in the opposite direction. Such a short time may not allow charge transport to a long distance. In other words, radiation in the LWIR field may theoretically wiggle the charges around its initial location, but may not efficiently transfer them to another luminescent site for photon upconversion to visible light.

Other upconversion mechanisms that do not require charge transfer between different luminescent sites, such as multiphoton absorption, may be limited by the quantum mechanic nature of high-order transitions. At higher frequencies (e.g., visible light), light may act in a quantum-mechanical fashion, understood in terms of quanta of energy (photons) that are absorbed when they reach the energy of a quantum-mechanical excited-state (exciton) QD wavefunction, i.e., multiphoton absorption. Such mechanism is distinct from the classical regime of THz electric field, which, at sufficient amplitudes, becomes strong enough to move classical charges from one particle to another. However, quantum regimes of action may not directly translate to the intermediate frequency ranges at MIR for multiphoton absorption. For example, it is rare to observe more than five photon absorption sites, as the efficiency decreases significantly for a higher number of photon absorption. A cross-section for four-photon absorption in fluorescein is about 60 orders of magnitude smaller than two-photon absorption. As such, it may be difficult to use multiphoton absorption to upconvert LWIR light to visible light detectable by a silicon-based sensor.

According to one or more examples of the disclosure, upconversion films and devices may enhance field-induced photon upconversion processes by increasing a strength and uniformity of an electric field in an optically-responsive upconversion material. An upconversion film includes a gap electrode layer having an array of discrete apertures that each form a capacitive gap between two electrodes. The capacitive gap defines an optical field for receiving infrared light through a narrow aperture and includes the upconversion material for converting the infrared light to visible light. An electric field generated across the capacitive gap induces an electric field-driven charge transfer in the upconversion material to upconvert (i.e., increase a frequency of) infrared light received by the array of discrete apertures into visible light. The capacitive gap may be relatively small, such as sub-resonant wavelength scale for long wavelength infrared, resulting in an enhanced and relatively uniform electric field in the capacitive gap. During manufacture, a size of the capacitive gap may be formed using highly controllable deposition methods, such as atomic layer lithography or photolithography, such that the resulting capacitive gaps may be defined by geometric sidewalls and emit visible light with high sensitivity.

Upconversion films described herein may be used in combination with imaging components to form a polarization-insensitive high-resolution infrared camera. Typical infrared cameras may be limited to relatively low resolutions due to pixel structures that receive the infrared light. In some examples described in this disclosure, an individual discrete aperture with a sub-wavelength scale (e.g., below 1 μm) capacitive gap may operate as a single pixel, which may be substantially smaller than a typical infrared camara's pixel size of 10-20 μm. The array of discrete apertures of upconversion films described herein may be optically coupled to an array of sensing elements, such as photosites or photodiodes. Visible light that is upconverted by a discrete aperture may be received by a corresponding photodiode to generate an electric signal representing an intensity of the visible light. In this way, upconversion films may enable LWIR cameras to operate at high resolutions with a small pixel size and high sensitivity.

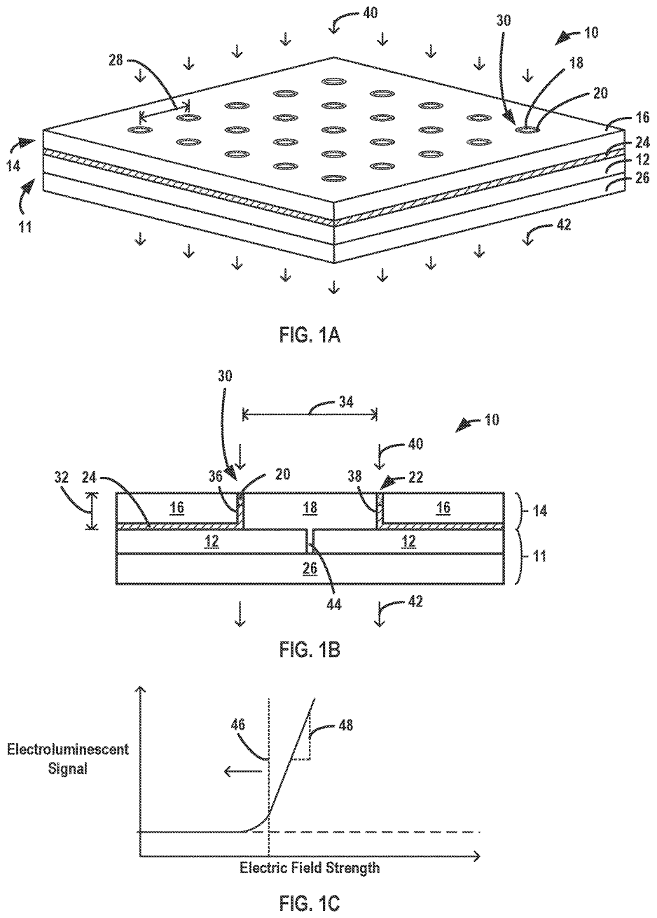

FIG. 1A is a perspective view conceptual and schematic diagram illustrating a portion of an example upconversion film 10 for upconverting infrared light to visible light, while FIG. 1B is a side view cross-sectional conceptual and schematic diagram illustrating the example upconversion film 10 of FIG. 1A. Upconversion film 10 is configured to upconvert infrared light 40 to visible light 42 using photon upconversion enhanced by an electric field. Upconversion film 10 may be incorporated into a wide variety of devices and systems, such as a camera, polarimeter, or other device that may manipulate or measure visible light emitted in response to infrared light. In the example of FIG. 1A, upconversion film 10 includes a gap electrode layer 14 and a substrate 11 underlying gap electrode layer 14.

Substrate 11 may be configured to transmit light at desired wavelengths, such as visible light emitted from gap electrode layer 14. In the example of FIG. 1A, in which an electrical bias may be applied to gap electrode layer 14, substrate 11 includes a dielectric layer 12 and an optically transparent electrode layer 26 underlying dielectric layer 12. However, in other examples, such as devices in which an electrical bias is not applied to gap electrode layer 14, substrate 11 may include an optically transparent insulative or semiconductive layer, such as sapphire, silicon, calcium difluoride, and the like.

Upconversion film 10 includes gap electrode layer 14 overlying dielectric layer 12. Gap electrode layer 14 includes a continuous electrode 16 and an array of discrete electrodes 18 distributed within continuous electrode 16. While illustrated as a single electrode, continuous electrode 16 may include more than one segment. Each of the array of discrete electrodes 18 and continuous electrode 16 may be formed from a conductive or semiconductive material including, but not limited to: metals, such as platinum, silver, copper, gold, aluminum, lithium, or nickel; nonmetals, such as graphene; polymers, such as conductive polymers; ceramics, such as indium tin oxide; semiconductors; and the like. In some examples, the array of discrete electrodes 18 and continuous electrode 16 may include a same composition, while in other examples the array of discrete electrodes 18 and continuous electrode 16 may include different compositions.

In the example of FIG. 1A, gap electrode layer 14 includes a passivation layer 24 between continuous electrode 16 and dielectric layer 12. As will be described further below, passivation layer 24 may be used to carefully control a width of a capacitive gap between the array of discrete electrodes 18 and continuous electrode 16. In some examples, passivation layer 24 may be configured to reduce quenching, such as by bounding an upconversion material 20 within a capacitive gap. Passivation layer 24 may be formed from an optically transparent, minimally reactive material including, but not limited to, titanium oxide, aluminum oxide, and the like.

Gap electrode layer 14 includes an array of discrete apertures 30 between the array of discrete electrodes 18 and continuous electrode 16. The array of discrete apertures 30 are configured with geometric parameters to enhance an electrical field to further induce luminescence in upconversion material 20, as will be described further below.

Gap electrode layer 14 includes upconversion material 20 in at least a portion of each capacitive gap of the array of discrete apertures 30. Upconversion material 20 is configured to upconvert infrared light to visible light in response to an applied electric field. A variety of upconversion materials may be used including, but not limited to, semiconductor nanocrystals, an organic light-emitting polymer, quantum dots, a material having a perovskite structure, or other materials capable of emitting infrared light in response to higher wavelength radiation.

In some examples, upconversion material 20 may be configured to respond to an electrical field by transferring electrons between luminescent subsystems of upconversion material 20. Gap electrode layer 14 may be configured to boost the electric field inside the capacitive gap, which may induce the field-driven charge transfer within upconversion material 20 filled in the capacitive gap. As a result, IR upconversion to visible light occurs via IR field-driven luminescence.

In some examples, upconversion material 20 may include quantum dots. Quantum dots may be configured to efficiently upconvert radiation in the LWIR field. For example, quantum dots may have a controllable and small size, may be configured to be close to other quantum dots, and may have an exceptionally high emission quantum yield. Various properties of quantum dots, such as a size, spacing, and/or composition, may be tailored for charge transfer between luminophores and subsequent efficient electroluminescence under LWIR light.

In some examples, upconversion material 20 may include quantum dots having a perovskite structure (e.g., having a crystal structure of ABX₃, in which A and B are positively charged ions and X is a negatively charged ion). Perovskite quantum dots may be better at upconverting THz-to-visible light than traditional core-shell quantum dots. For example, perovskite quantum dots may have improved emission coherence and quality, as an interdot spacing may be reduced with a better (e.g., shorter or no) ligand configuration. As a result, upconversion material 20 may have a higher density of charge sites, which may be particularly advantageous for LWIR detection in which spacing may be a limiting factor of photon upconversion.

Substrate 11 includes dielectric layer 12 overlying optically transparent electrode layer 26. Dielectric layer 12 may be configured to electrically separate continuous electrode layer 16 from optically transparent electrode layer 26 and permit electrical coupling from optically transparent electrode layer 26 to the array of discrete electrode 18, such as through a via or other electrical connection. Dielectric layer 12 may be selected for a variety of properties including, but not limited to, a high stress or strain, a low reactivity (high inertness), or the like. Dielectric layer 12 may be formed from an electrically insulating dielectric material including, but not limited to, silica, aluminum oxide, titanium oxide, and the like. In some examples, dielectric layer 12 may include an amorphous silica.

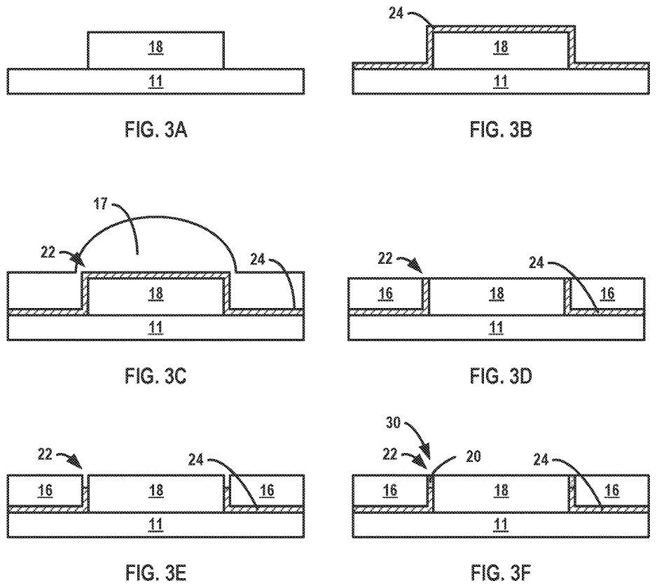

In some examples, the array of discrete electrodes 18, continuous electrode 16, dielectric layer 12, and/or passivation layer 24 may be formed from materials suitable for sputtering, vapor, or atomic layer deposition. For example, as will be explained in FIGS. 3A-3G, FIG. 4, FIGS. 5A-5E, FIG. 6, FIGS. 7A-7J, FIG. 8, FIGS. 9A-9J, and FIG. 10 below, upconversion film 10 may be formed using atomic layer lithography and/or photolithography techniques, such that layers may be produced relatively simply and with high geometric accuracy.

In the example of FIG. 1A and FIG. 1B, substrate 11 includes an optically transparent electrode layer 26. Optically transparent electrode layer 26 is formed from an optically transparent conductive material configured to transmit visible light and conduct electricity between one or more components electrically coupled to optically transparent electrode layer 26. Optically transparent electrode layer 26 may be electrically coupled to the array of discrete electrodes 18. In some examples, substrate 11 may include an optically transparent insulative or adhesive layer. For example, the array of discrete electrodes 18 may be electrically coupled to an array of conductors on an insulative substrate, such that portions of the array of discrete electrodes 18 may receive electric current having different properties.

In some examples, upconversion material 20 is configured to upconvert long wave infrared light to visible light. Upconversion material 20 may receive LWIR light from an excitation source, such as a room temperature object, and emit shorter wavelength visible light. This upconversion of photons may be further enhanced by applying an electric field to upconversion material 20. For example, an electric field applied to upconversion material 20 that includes quantum dots may induce charge transfer between the quantum dots, resulting in increased electroluminescence from upconversion material 20.

Referring to FIG. 1B, the array of discrete electrodes 18, continuous electrode 16, and the array of discrete apertures 30 may have a variety of geometric properties that permit improvement and/or customization of various optical and electrical properties of upconversion film 10. Each discrete aperture 30 is defined by a capacitive gap 22 between a discrete electrode 18 and continuous electrode 16. The electroluminescent enhancement may be dependent on a strength and distribution of the electric field in capacitive gap 22. As such, capacitive gap 22 may be sufficiently small to concentrate an electrical field across capacitive gap 22. In some examples, each capacitive gap is less than about 100 nanometers (nm). In some examples, each capacitive gap is less than about 20 nm.

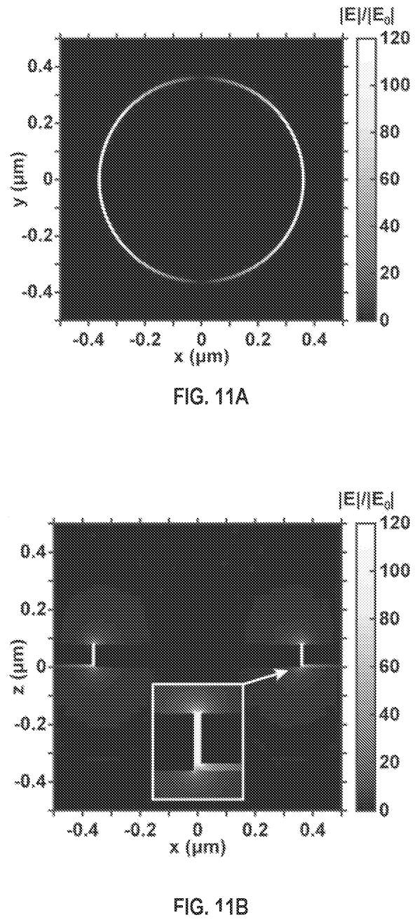

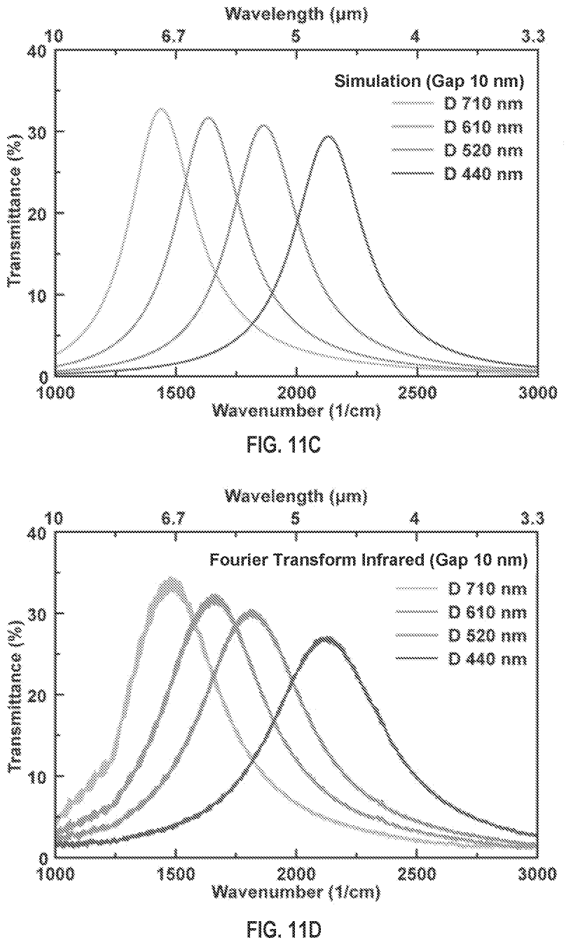

Upconversion material 20 and capacitive gap 22 are configured to increase conversion efficiency of discrete aperture 30 in response to application of an electric field across capacitive gap 22. Without being limited to any particular example, a small (e.g., nanometer scale) capacitive gap 22 may be an efficient nanostructure to increase optical fields at a deep subwavelength dimension of infrared light via surface plasmons. An annular geometry of capacitive gap 22 may have certain unique optical properties at its cutoff frequency, such as optical transmission over 1000%, relatively uniformly extended electric field distribution, strong electric field enhancement, and/or high impedance matching. FIGS. 11A and 11B illustrate such optical properties of the array of discrete apertures 30. FIG. 11A is a top view schematic diagram of a horizontal distribution of an electric field enhancement factor (E/E₀) through a capacitive gap of an aperture, while FIG. 11B is a cross-sectional side view schematic diagram of a vertical distribution of an electric field enhancement factor (E/E₀) through a capacitive gap of an aperture.

In some examples, the array of discrete apertures 30 may have a shape configured to substantially capture unpolarized light. For example, discrete aperture 30 may have a circular shape that permits light having various oscillation orientations to pass through. As a result, an intensity of visible light emitted by each discrete aperture 30 may be relatively uniform, such as illustrated in FIG. 11A.

Discrete electrodes 18 and continuous electrode 16 may have any thickness sufficient to provide a current path. In some examples, thickness 28 of continuous electrode 16 and/or discrete electrode 18 is less than about five micrometers. A sidewall of each discrete electrode of the array of discrete electrodes faces a sidewall of the continuous electrode. In some examples, an average roughness of each of the sidewall of each discrete electrode and the sidewall of the continuous electrode may be relatively low, such as due to the use of photoresist or other lithographic layers, rather than the use of subtractive machining processes having higher roughness.

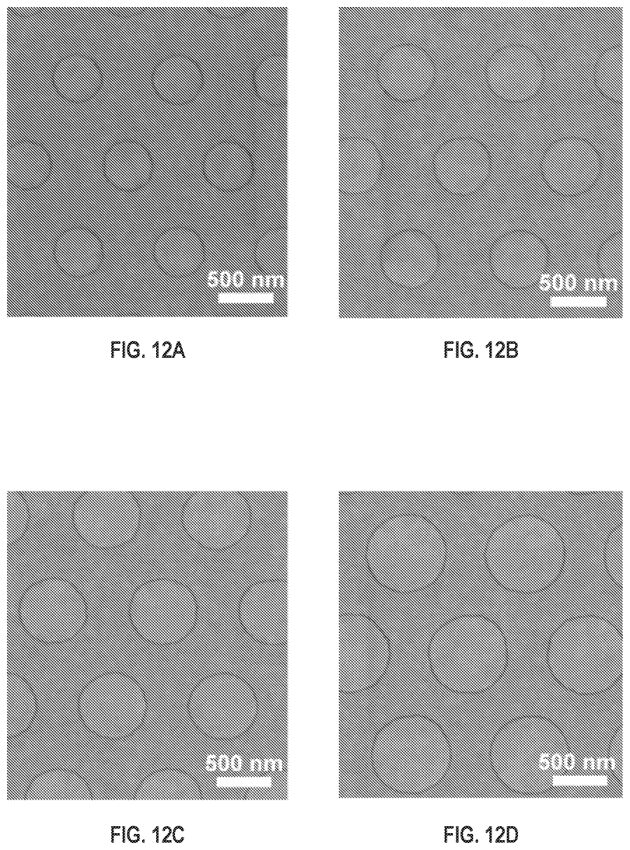

Discrete electrodes 18 may have a diameter selected for a particular resonance frequency or range of resonance frequencies. FIG. 11C is a graph of transmittance versus wavenumber for different diameters of apertures using finite element method (FEM) modeling, while FIG. 11D is a graph of transmittance versus wavenumber for different diameters of apertures using Fourier transform infrared (FTIR) spectroscopy. As illustrated in FIGS. 11C and 11D, a transmittance through a discrete aperture 30 may depend on a wavenumber of incident light and diameter of the corresponding discrete electrode 18. FIGS. 12A, 12B, 12C, and 12D are SEM images of arrays of apertures having a 10 nm capacitive gap and 440 nm, 520 nm, 610 nm, and 710 nm diameters, respectively. Tunable resonance frequencies for discrete electrodes 18 may enable multiplexed structures, such as a series of discrete electrodes 18 having increasing or decreasing size, that may be selected for difference resonance frequencies. For example, a wavelength multiplexing scheme may permit the development of a mini spectrometer for LWIR light.

While illustrated in FIG. 1A as having a circular shape and arranged in a square lattice arrangement, discrete electrodes 18 of the array of discrete electrodes 18 may have any of a variety of shapes or patterns. The array of discrete electrodes 18 may have a pitch 28 between centers of adjacent discrete electrodes 18 and a pattern among the array of discrete electrodes 18. Patterns may include, but are not limited to, grid patterns, circular patterns, and the like. Shapes may include, but not limited to, circular, elliptical, rectangular, square, and the like. In some examples, a pattern of the array of discrete electrodes 18 may be selected based on a desired pattern density. For example, a hexagonal lattice arrangement of the array of discrete electrodes 18 may form a compact and high resolution pattern. In some examples, a pattern of the array of discrete electrodes 18 may be selected based on an underlying configuration of a component that interacts with upconversion film 10. For example, the array of discrete electrodes 18 may be patterned above an array of photodiodes having a grid pattern, such that the array of discrete electrodes 18 may have a grid pattern. In some examples, the array of discrete electrodes may have a pitch 28 that is less than about 2 micrometers (μm).

In some examples, dielectric layer 12 includes an array of electrically conductive vias 44 electrically coupling the array of discrete electrodes 18 to optically transparent electrode layer 26. Each via 44 includes an electrically conductive or semiconductive material. In some examples, each via 44 may be continuous with a corresponding discrete electrode 18.

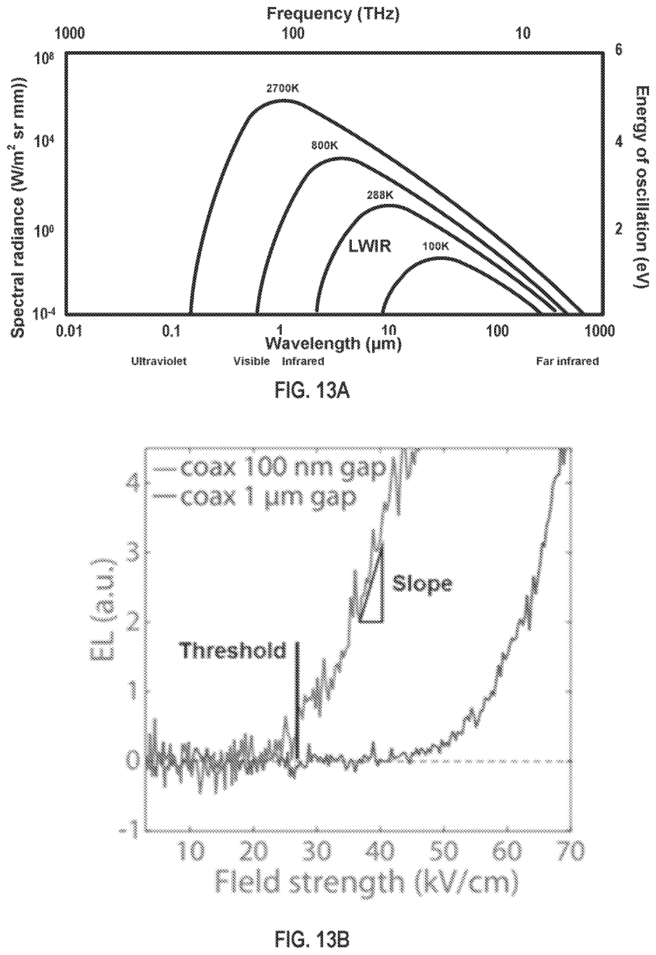

In operation, upconversion film 10 may be configured to efficiently upconvert infrared light 40 to visible light 42 by enhancing the efficiency of upconversion material 20 within discrete apertures 30. Without being limited to any particular theory, a heated object may emit radiation having a wavelength that is determined by a temperature of the object. As the object heats up, a spectral radiance of the object increases. FIG. 13A is a graph of spectral radiance of black body radiation for various temperatures of objects. As illustrated in FIG. 13A, radiation emitted by objects in a typical human environment may generally fall into the long wavelength infrared light (LWIR) regime, ranging from about 8 micrometers (μm) to about 14 μm, such that an infrared thermal camera configured to detect radiation in a LWIR regime may image the object or environment.

Upconversion film 10 may upconvert infrared light 40 emitted from an object into visible light 42 in proportion to the spectral radiance. Temperature variation of the object may be measured by measuring a change in intensity of visible light 42 from infrared light 40. FIG. 1C is an exemplary graph of an electroluminescent signal versus electric field strength. As illustrated in FIG. 1C, thermal sensitivities, including noise equivalent temperature difference (NETD) and minimum resolvable temperature difference (MRTD), may be determined by an intensity of visible light as a function of LWIR incident field strength. The threshold field strength 46 to induce the luminescence indicates the NETD and the slope of the intensity increment 48 indicates the MRTD, As a width of capacitive gap 22 decreases, threshold field strength 46 may decrease, as indicated by the arrow. Similarly, FIG. 13B is a graph of terahertz-to-visible photon upconversion versus electric field strength for a 100 nm and a 1 μm capacitive gap.

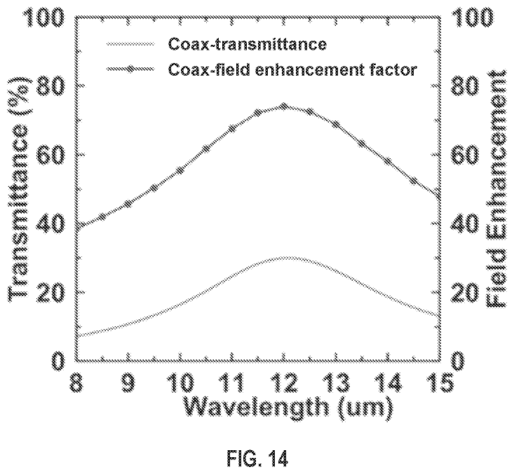

In the field-induced upconversion process, local field enhancement may be an important factor to determine a threshold field strength inducing the visible light emission, which is associated with the NETD. FIG. 14 is a graph of transmittance and electric field enhancement through an upconversion film versus wavelength using finite-difference time domain (FDTD) simulation. As illustrated in FIG. 14, capacitive gap 22 possesses the high field enhancement all the way through the LWIR range (8 μm to 14 μm in wavelength). As such, capacitive gap 22 may efficiently couple unpolarized light, such that capacitive gap 22 having the upconversion material 20 may also efficiently emit visible light along the entire capacitive gap 22.

For an IR detection application, an imaging system may have a broad field enhancement and polarization-independent resonant structure. As illustrated in FIG. 14, the coaxial nanogap possesses a broad resonance covering the LWIR band and is independent of polarization. As such, the single coaxial nanogap may efficiently emit the visible light from the whole nanogap through unpolarized natural IR light, which is greatly beneficial for making the pixel. As such, the discrete aperture having a capacitive gap may be an ideal unit cell element for IR-to-visible photon upconversion due to these optical properties.

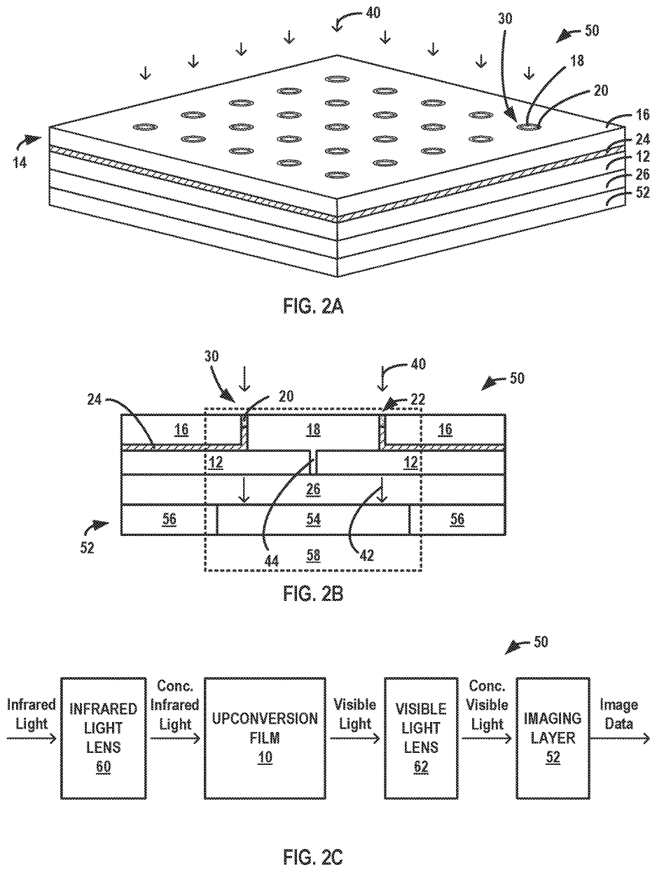

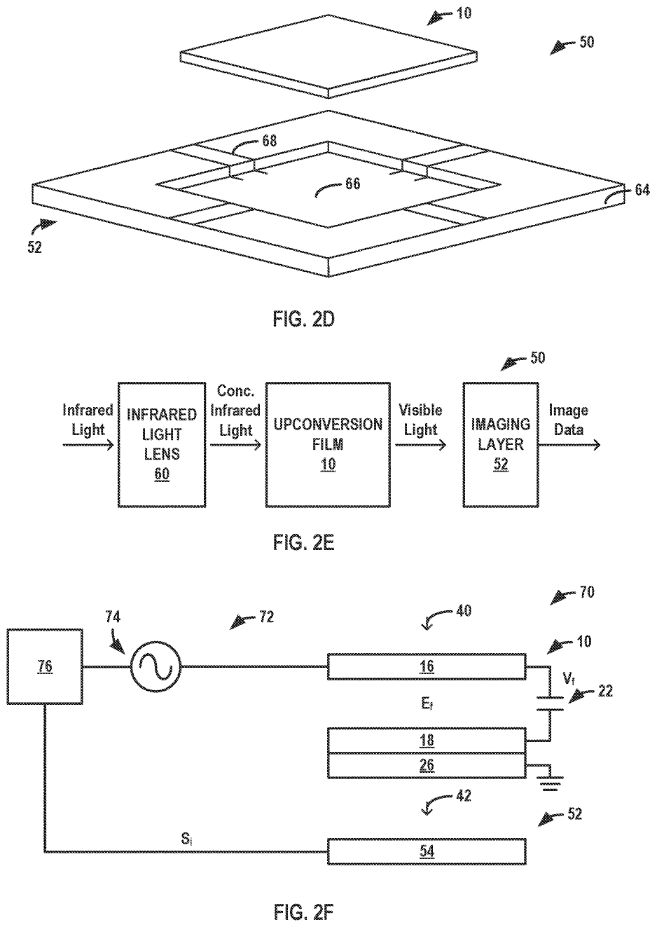

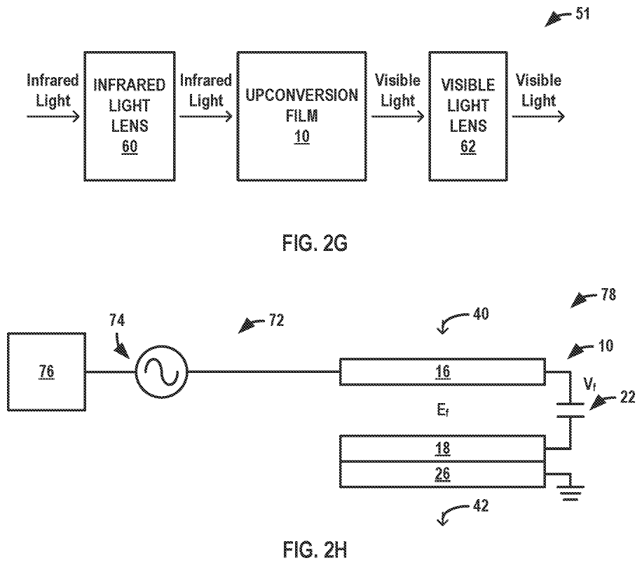

FIG. 2A is a perspective view conceptual and schematic diagram illustrating an example upconversion portion of an infrared camera for upconverting infrared light to visible light, while FIG. 2B is a side view cross-sectional conceptual and schematic diagram illustrating the example upconversion portion of the infrared camera of FIG. 2A. Infrared camera 50 includes a substrate 11, including optically transparent electrode layer 26 and dielectric layer 12, and upconversion film 10, including gap electrode layer 14 of FIGS. 1A and 1B, and an imaging layer 52.

Infrared camera 50 may utilize upconversion film 10 in combination with an imaging layer 52. Imaging layer 52 may be configured to detect visible light 42 converted from infrared light 40 by upconversion film 10. While described as a layer, imaging layer 52 may include various components or devices, such as visible image sensors (e.g., CMOS or CCD). Imaging layer 52 includes an array of sensing elements 54 in a substrate 56. Each sensing element 54 is configured to detect an intensity of a portion of visible light 42.

In some examples, imaging layer includes at least one of a charge coupled device (CCD) sensor or a complementary metal-oxide semiconductor (CMOS) image sensor. In such examples, the array of sensing elements 54 includes an array of photosites configured to convert photons to an electrical charge and quantify the electrical charge of each photosite into a measurement signal representing an intensity of light. In some examples, imaging layer 52 includes a photodiode sensor. In such examples, the array of sensing elements 54 includes an array of photodiodes configured to generate an electrical current as a measurement signal representing an intensity of light.

Each discrete aperture of the array of discrete apertures 30 is aligned with a sensing element of the array of sensing elements 54. In some examples, pitch 28 and the pattern of the array of discrete electrodes 18 may be configured for a particular underlying configuration of imaging layer 52 underlying optically transparent electrode layer 26. The array of discrete apertures 30 of upconversion film 10 and the array of sensing elements 54 of imaging layer 52 are configured to form discrete pixels 58 for detecting images of visible light 42 from images of infrared light 40. For example, capacitive gap 22 may be smaller than a resonant wavelength of infrared light 40, such as 5-10 times smaller, and may be independent of a polarization of infrared light 40. As such, discrete aperture 30 may function as a single pixel 58 to illuminate visible light 42 independently at a subwavelength scale. As a result, infrared camera 50 may include an array of pixels 58 configured to upconvert an image of infrared light 40 into an image of visible light 42 and subsequently detect the image of visible light.

FIG. 2C is a side view block diagram illustrating an example infrared camera 50 of FIGS. 2A and 2B. In some examples, infrared camera 50 may include one or more additional components beyond upconversion film 10 and imaging layer 52 that may be configured to interface with infrared light 40 and/or visible light 42. Infrared camera 50 of FIG. 2C may include an infrared light lens 60 configured to receive infrared light and concentrate the infrared light. Upconversion film 10 may be configured to receive the infrared light from infrared light lens 60 and emit visible light in response to the infrared light and an applied electrical field. Infrared camera 50 may include a visible light lens 62 configured to receive the visible light from upconversion film 10 and concentrate the visible light. Imaging layer 52 may be configured to receive the visible light from the visible light lens 62 and generate image data from the visible light. The image data may represent an image of infrared light received by infrared camera 50.

To form infrared camera 50, upconversion film 10 may be combined with a visible light imaging chip as imaging layer 52. FIG. 2D is a diagram illustrating an example infrared camera arranged as a microchip for upconverting infrared light to visible light. Infrared camera 50 of FIG. 2D includes upconversion film 10 and imaging layer 52. Imaging layer 52 may include a sensor chip 66, a microchip package 64, and one or more connectors 68 configured to supply power to upconversion film 10 and pads (not shown) configured to couple to a power source.

Upconversion film 10 may be fabricated on or attached to imaging layer 52 (e.g., as sensor chip 66). In some examples, upconversion film 10 may be fabricated separately from imaging layer 52. For example, gap electrode layer 14 may be directly fabricated on optically transparent electrode layer 26, such as ITO-coated glass, such as in example upconversion film 10 of FIGS. 1A and 1B. Upconversion film 10 may then be coupled to imaging layer 52, such as by using an adhesive layer. For example, substrate 11 may include an adhesive layer, such as a biocompatible adhesive layer, underlying optically transparent electrode layer 26.

In some examples, rather than forming upconversion film 10 separately and optically coupling upconversion film 10 to imaging layer 52, upconversion film 10 may be fabricated directly on imaging layer 52. For example, optically transparent electrode layer 26 may be fabricated on imaging layer 52, and gap electrode layer 14 may be subsequently fabricated on optically transparent electrode layer 26. FIG. 2E is a side view block diagram illustrating an example infrared camera 50 of FIGS. 2A and 2B. Upconversion film 10 may be configured to receive the infrared light from infrared light lens 60 and emit visible light in response to the infrared light and an applied electrical field. In contrast to infrared camera 50 of FIG. 2C, infrared camera of FIG. 3E may not include a visible light lens 62, such that imaging layer 52 may be configured to receive the visible light from upconversion film 10 and generate image data from the visible light.

Upconversion film 10 and/or infrared camera 50 may include various components configured to control an applied electric field to upconversion film 10 and, in example infrared camera 50, collect and/or process image data from imaging layer 52. FIG. 2F is a block diagram illustrating an example system 70 for imaging infrared light. System 70 includes an upconversion film 10 that includes an array of discrete electrodes 18, a continuous electrode 16, and an optically transparent electrode layer 26, and an imaging layer 52 that includes an array of sensing elements 54.

Upconversion film 10 and imaging layer 52 are coupled to a control circuit 72. Control circuit 72 is configured to generate an electric field (E_{f}) across capacitive gap 22 and measure an intensity of visible light 42 converted from infrared light 40. Control circuit 72 includes a power source 74 and a controller 76, such as a computing device. Power supply 74 may include an AC or DC power source. Controller 76 may be configured to control power supply 74 to control a gap voltage (V_{f}) across capacitive gap 22 to generate an electric field across capacitive gap 22. The electric field generated by control circuit 72 may be sufficient to exceed a threshold electric field for detecting changes in electroluminescence. As described above, upconversion film 10 may be capable of generating strong electric fields inside capacitive gap 22 by reducing a width of capacitive gap 22, thereby confining infrared light 40 into smaller volumes and generating stronger local field intensity in the gap. Additionally, control circuit 72 may be configured to generate a strong electric field in capacitive gap 22 by directly applying a strong DC or AC electric fields across capacitive gap 22 to overcome a threshold field strength required for photon upconversion. For example, as illustrated in FIG. 1C, threshold 46 may be reached by applying a greater electric field strength across capacitive gap 22. Control circuit 72 may be configured to receive measurement signals (Si) from imaging layer 52. The measurement signals may indicate an intensity or change in intensity of visible light 42, converted from infrared light 40, that corresponds to a temperature or temperature variation of an object. In some examples, the measurement signals may indicate a polarization of visible light 42. For example, infrared light 40 passing through discrete aperture 30 may generate two dipoles at opposite sides of discrete aperture 30 that are in parallel with a polarization of infrared light 40, such that the measurement signals may indicate a spatial intensity of visible light 42 and, correspondingly, the polarization of infrared light 40.

While an infrared camera may use upconversion films described herein to digitally image infrared light, in some examples, upconversion films may be used to optically image infrared light, such as by emitting visible light that may be perceived unaided or minimally aided by a person. FIG. 2G is a side view block diagram illustrating an example optical imaging device 51. Imaging device 51 may include infrared goggles, infrared films, or other structures configured to emit visible light unaided or minimally aided, such as without a digital imaging layer. Imaging device 51 of FIG. 2G may include an infrared light lens 60 configured to receive infrared light and manipulate the infrared light, such as by concentrating or diffusing infrared light. Upconversion film 10 may be configured to receive the infrared light from infrared light lens 60 and emit visible light in response to the infrared light, with or without an applied electrical field. Imaging device 51 may include a visible light lens 62 configured to receive the visible light from upconversion film 10 and manipulate the visible light, such as by concentrating or diffusing the visible light. For example, the visible light may be manipulated to fill all or a portion of a screen.

FIG. 2H is a diagram illustrating an example system 78 for optically imaging infrared light, such as by using optical imaging device 51 of FIG. 2G. System 78 includes an upconversion film 10 that includes an array of discrete electrodes 18, a continuous electrode 16, and an optically transparent electrode layer 26, and an imaging layer 52 that includes an array of sensing elements 54. In examples in which upconversion film 10 is field-driven, such as shown in the example of FIG. 2H, system 78 may include upconversion film 10 coupled to a control circuit 72 configured to generate an electric field (E_{f}) across capacitive gap 22, similar to control circuit 72 of FIG. 2F. However, system 78 may not include imaging layer 52, such that control circuit 72 may only control the electric field across capacitive gap 22. In other examples in which upconversion film 10 is not field-driven, such as if a low or no power device is desired, system 78 may not include control circuit 72.

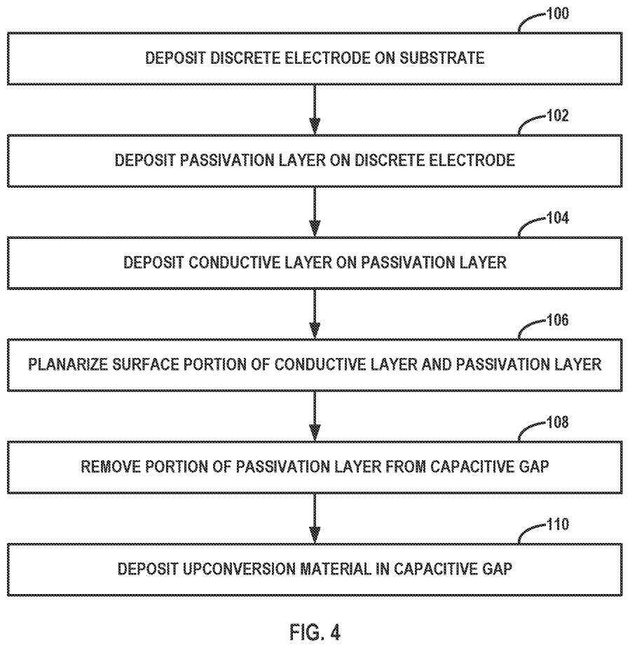

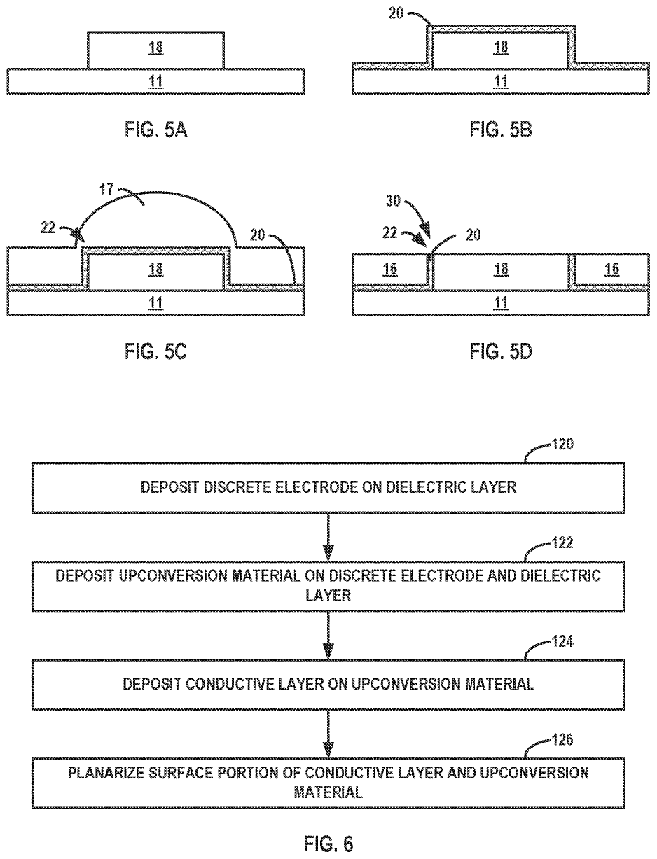

In some examples, upconversion films having apertures with narrow capacitive gaps filled with upconversion materials may be fabricated using atomic layer lithography and planarization techniques, such as ion milling or chemical-mechanical polishing. FIGS. 3A-3F and FIGS. 5A-SD illustrate various intermediate and final configurations for forming upconversion films, such as upconversion film 10 of FIGS. 1A-1B and 2A-2E, using atomic layer lithography and planarization. FIGS. 4 and 6 are flow diagrams illustrating example techniques for manufacturing an upconversion film for upconverting infrared light to visible light with upconversion materials inserted with (FIG. 4) or without (FIG. 6) a passivation layer. The techniques of FIGS. 4 and 6 will be described with reference to FIGS. 3A-3F and FIGS. 5A-SD, respectively; however, it will be understood that the methods of FIGS. 4 and 6 may be used to form other upconversion films or devices having other configurations, and that the upconversion films and devices of FIGS. 1A-1B and 2A-2E may be formed using other techniques.

The technique of FIG. 4 includes depositing an array of discrete electrodes on a substrate (100). FIG. 3A is a side view cross-sectional conceptual and schematic diagram illustrating an example deposition of a discrete electrode 18 on substrate 11. Substrate 11 may include any of a variety of substrates that are optically transparent to infrared and/or visible light, such as amorphous silicon. In some examples, substrate 11 may include imaging layer 52, such as a CCD or CMOS sensor chip.

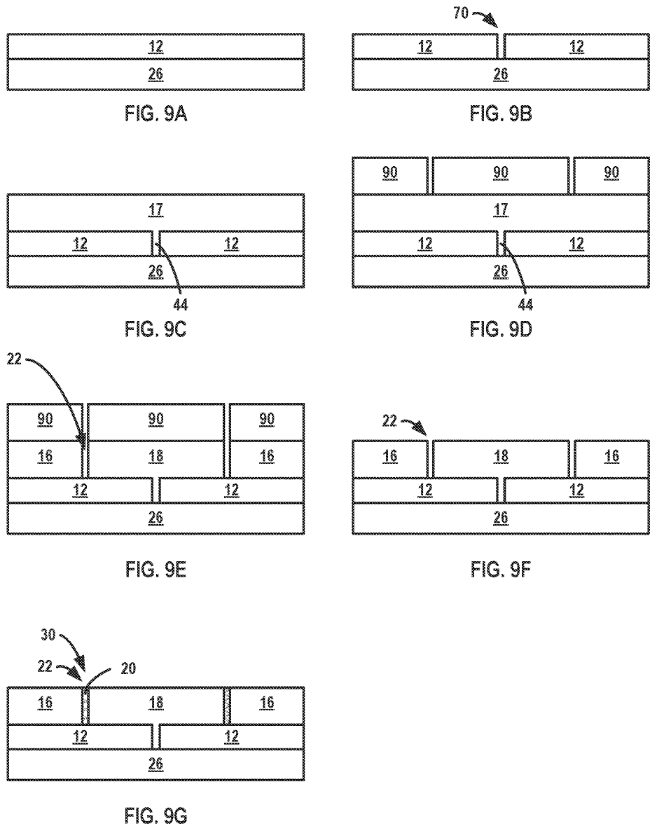

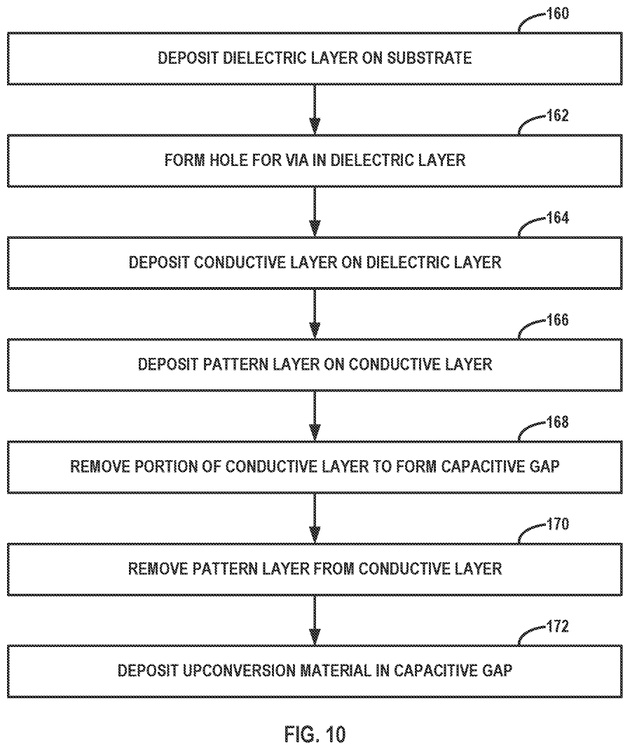

In some examples, depositing discrete electrode 18 may include applying a pattern of an array of metallic disks using standard lithography, metal deposition, and/or lift-off. For example, metallic disks having a variety of electrode shapes, such as circular, elliptical, square, or rectangular, may be patterned on a film, applied to substrate 11, and lifted off to deposit discrete electrode 18. In other examples, depositing discrete electrode 18 may include depositing a conductive layer, applying a negative-tone resist layer to form a positive photoresist layer on the conductive layer, etching the conductive layer to form the array of metallic disks, and removing the photoresist layer, such as will be described in FIGS. 9C-9F and steps 164-170 of FIG. 10 below.

The technique of FIG. 4 includes depositing a passivation layer on the array of discrete electrodes (102). FIG. 3B is a side view cross-sectional conceptual and schematic diagram illustrating an example deposition of passivation layer 24 on discrete electrode 18 and a portion of the substrate 11 of FIG. 3A. Discrete electrode 18 may be conformally coated with passivation layer 24, such as an insulating film, grown by atomic layer deposition (ALD) on a sidewall of discrete electrode 18. ALD may be configured to carefully control a thickness of passivation layer 24, such as with angstrom-scale resolution. For example, passivation layer 24 may be deposited by ALD for a particular amount of time and/or at a particular rate to produce a relatively uniform passivation layer 24 having low thickness. As described above in FIGS. 1A and 1B, passivation layer 24 may include aluminum oxide, silicon dioxide, titanium oxide, and the like.

The technique of FIG. 4 includes depositing a conductive layer on the passivation layer (104), FIG. 3C is a side view cross-sectional conceptual and schematic diagram illustrating an example deposition of a conductive layer 17 on passivation layer 24 of FIG. 3B. After deposition of conductive layer 17, passivation layer 24 grown on a sidewall of discrete electrode 18 may create capacitive gap 22 with a sidewall of continuous electrode 16 formed from conductive layer 17.

The technique of FIG. 4 includes planarizing a surface portion of the conductive layer and a surface portion of the passivation layer (106). FIG. 3D is a side view cross-sectional conceptual and schematic diagram illustrating an example planarization, operation of a surface portion of conductive layer 17 and passivation layer 24 of FIG. 3C. Conductive layer 17 may include an excess of material, while a portion of passivation layer 24 may cover a surface portion of discrete electrode 18. A planarization technique, such as a low-angle ion milling process or a chemical-mechanical polishing process, may selectively shave off overlayered conductive material of conductive layer 17 until a surface of discrete electrode 18 and continuous electrode 16 becomes substantially planar, thereby forming conductive layer 17 into continuous electrode 16 and opening an entrance of capacitive gap 22 embedded between discrete electrode 18 and continuous electrode 16.

Once the capacitive gap has been formed and the passivation layer exposed, at least a portion of the passivation layer may be replaced with an upconversion material. The technique of FIG. 4 includes removing a portion of the passivation layer from the capacitive gap between the array of discrete electrodes and the continuous electrode (108). FIG. 3E is a side view cross-sectional conceptual and schematic diagram illustrating an example removal of a portion of passivation layer 24 of FIG. 3D. A variety of techniques may be used to remove the portion of passivation layer 24 including, but not limited to, etching, evaporation, and the like. For example, an etchant, such as heated phosphoric acid, may remove a surface portion of passivation layer 24. As a result, a portion of capacitive gap 22 may be available for depositing upconversion material 20.

The technique of FIG. 4 includes depositing the upconversion material into the capacitive gap. FIG. 3F is a side view cross-sectional conceptual and schematic diagram illustrating an example deposition of upconversion material 20 in capacitive gap 22 between the continuous electrode 16 and discrete electrode 18 of FIG. 3E. A variety of techniques may be used to deposit the upconversion material including, but not limited to, spin coating, vapor deposition, and the like. The resulting upconversion film includes capacitive gap 22 generated along a perimeter of discrete electrode 18, in which a thickness of passivation layer 24 defines a width of capacitive gap 22. As such, the technique of FIG. 4 may separately control a diameter of discrete electrode 18 and a width of capacitive gap 22. Any closed-loop aperture patterns (e.g., circle, ellipse, rectangle, square, etc.) may be fabricated using this technique, regardless of a geometry or pattern density.

In some examples, rather than removing a portion of a passivation layer and depositing an upconversion material, an upconversion material may be directly deposited prior to forming a continuous electrode. Referring to FIG. 6, the technique of FIG. 6 includes depositing an array of discrete electrodes on a substrate (120), such as described in step 100 of FIG. 4. FIG. 5B is a side view cross-sectional conceptual and schematic diagram illustrating an example deposition of a discrete electrode 18 on substrate 11.

The technique of FIG. 6 includes depositing a layer of an upconversion material on the array of discrete electrodes (122). FIG. 5B is a side view cross-sectional conceptual and schematic diagram illustrating an example deposition of upconversion material 20 on discrete electrode 18 of FIG. 5A. Upconversion material 20 may be deposited directly (or indirectly, via another layer) on discrete electrode 18 to a desired thickness. In some examples, a thin passivation layer (not shown) may be deposited on discrete electrode 18 prior to and/or after depositing upconversion material, such as to reduce quenching.

The technique of FIG. 6 includes depositing a conductive layer on the layer of upconversion material (124), similar to step 104 of FIG. 4. FIG. 5C is a side view cross-sectional conceptual and schematic diagram illustrating an example deposition of conductive layer 17 on upconversion material 20 of FIG. 5B. After deposition of conductive layer 17, upconversion material 20 deposited on a sidewall of discrete electrode 18 may create capacitive gap 22 with a sidewall of continuous electrode 16 formed from conductive layer 17.

The technique of FIG. 6 includes planarizing a surface portion of the conductive layer and a surface portion of the layer of the upconversion material (126), similar to step 106 of FIG. 4. FIG. 5D is a side view cross-sectional conceptual and schematic diagram illustrating an example planarization operation of a surface portion of conductive layer 17 and upconversion material 20 of FIG. 5D. Conductive layer 17 may include an excess of material, while a portion of passivation layer 24 may cover a surface portion of discrete electrode 18. A planarization technique may selectively shave off overlayered conductive material of conductive layer 17 until a surface of discrete electrode 18 and continuous electrode 16 becomes substantially planar, thereby forming conductive layer 17 into continuous electrode 16 and opening an entrance of capacitive gap 22 embedded between discrete electrode 18 and continuous electrode 16.

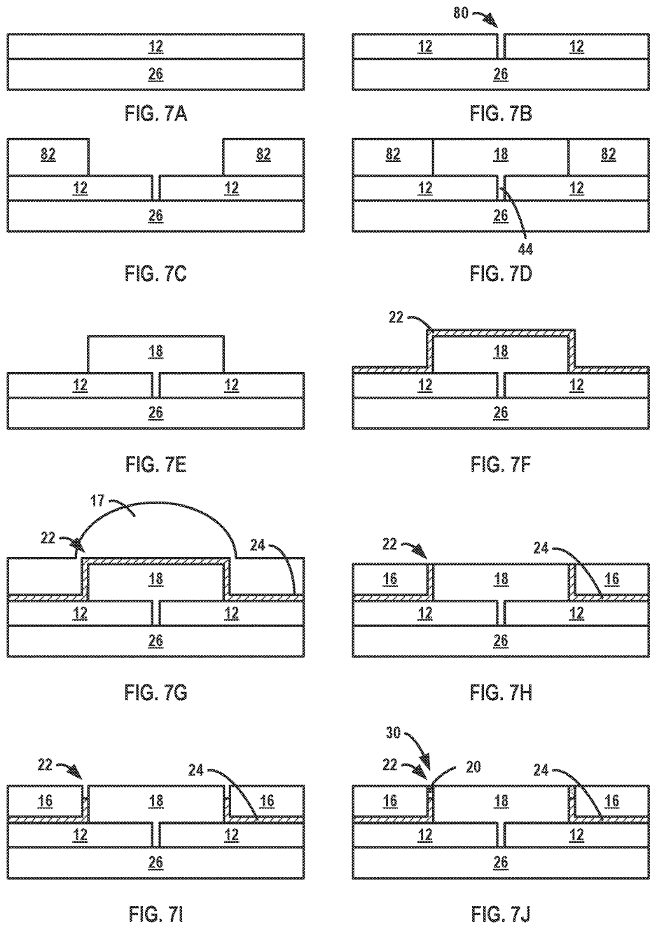

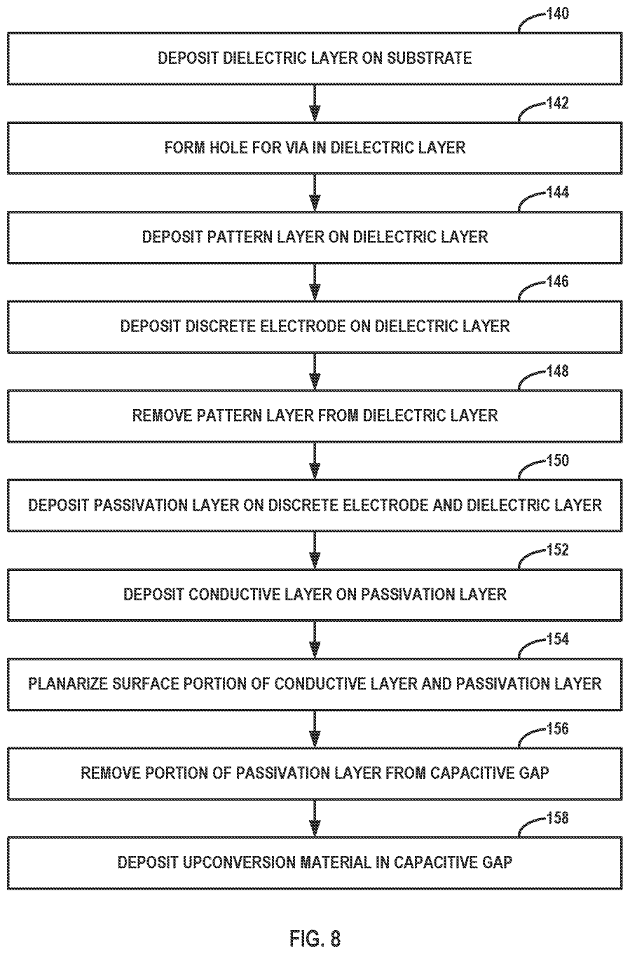

In some examples, upconversion films having apertures with narrow capacitive gaps filled with upconversion materials may be fabricated using photolithography, atomic layer lithography, and ion polishing. FIGS. 7A-7J illustrate various intermediate and final configurations for forming upconversion films, such as upconversion film 10 of FIGS. 1A-1B and 2A-2E, using photolithography, atomic layer lithography, and ion polishing. FIG. 8 is a flow diagram illustrating example techniques for manufacturing an upconversion film for upconverting infrared light to visible light. The technique of FIG. 8 will be described with reference to FIGS. 7A-7J; however, it will be understood that the technique of FIG. 8 may be used to form other upconversion films or devices having other configurations, and that the upconversion films and devices of FIGS. 1A-1B and 2A-2E may be formed using other techniques.

The technique of FIG. 8 includes depositing a dielectric layer on a substrate (140). FIG. 7A is a side view cross-sectional conceptual and schematic diagram illustrating an example deposition of dielectric layer 12 on a substrate, such as optically transparent electrode layer 26 (as shown) or another substrate, such as a glass or silicon substrate (not shown). A variety of methods may be used to deposit dielectric layer 12 including, but not limited to, sputtering, vapor, or atomic layer deposition. Dielectric layer 12 may be formed from an electrically insulating dielectric material including, but not limited to, silica, aluminum oxide, titanium oxide, and the like.

In some examples, the technique of FIG. 8 may include forming a hole in the dielectric layer to be filled with a conductive material as a via (142). FIG. 7B is a side view cross-sectional conceptual and schematic diagram illustrating an example formation of a hole 80 for a via 44 in dielectric layer 12 of FIG. 7A. Hole 80 may extend from an upper surface of dielectric layer 12 to an upper surface of optically transparent electrode layer 26, such that a molten metal or other material may flow into hole 80 and form an electrical connection between a concurrently or subsequently deposited discrete electrode 18.

The technique of FIG. 8 includes depositing a pattern layer on the dielectric layer (144). FIG. 7C is a side view cross-sectional conceptual and schematic diagram illustrating an example deposition of pattern layer 82 on dielectric layer 12 of FIG. 7B. Pattern layer 82 may be configured to provide a template for forming discrete electrode 18. In the example of FIG. 7C, pattern layer 82 includes a large hole formed on top of hole 80. Pattern layer 82 may include relatively smooth sidewalls, such that a conductive material deposited into the hole formed by pattern layer 82 may have correspondingly smooth sidewalls compared to sidewalls formed from subtractive machining processes.

The technique of FIG. 8 includes depositing an array of discrete electrodes on the dielectric layer (146). FIG. 7D is a side view cross-sectional conceptual and schematic diagram illustrating an example deposition of discrete electrode 18 on dielectric layer 12 of FIG. 7C. A conductive material may be deposited into the hold of pattern layer 82 and subsequently evaporated to form discrete electrode 18 and via 44, thereby electrically coupling discrete electrode 18 to optically transparent electrode layer 26.

The technique of FIG. 8 includes removing the pattern layer from the dielectric layer (148). FIG. 7E is a side view cross-sectional conceptual and schematic diagram illustrating an example removal of pattern layer 82 from dielectric layer 12 of FIG. 7D. Pattern layer 82 may be removed through a liftoff process. As a result, various sidewall surfaces of discrete electrode 18 may be exposed.

The technique of FIG. 8 includes depositing a passivation layer on the array of discrete electrodes (150), similar to step 102 of FIG. 4. FIG. 7F is a side view cross-sectional conceptual and schematic diagram illustrating an example deposition of passivation layer 24 on discrete electrode 18 of FIG. 7E. Discrete electrode 18 may be conformally coated with passivation layer 24 grown by ALD on a sidewall of discrete electrode 18. As described above, ALD may be configured to carefully control a thickness of passivation layer 24 to produce a relatively uniform passivation layer 24 having low thickness.

The technique of FIG. 8 includes depositing a conductive layer on the passivation layer (152), similar to step 104 of FIG. 4. FIG. 7G is a side view cross-sectional conceptual and schematic diagram illustrating an example deposition of conductive layer 17 on passivation layer 24 of FIG. 7F.

The technique of FIG. 8 includes planarizing a surface portion of the conductive layer and passivation layer (154), similar to step 106 of FIG. 4. FIG. 7H is a side view cross-sectional conceptual and schematic diagram illustrating an example planarization operation of a surface portion of conductive layer 17 and passivation layer 24 of FIG. 7G. As a result, capacitive gap 22 is generated along a perimeter of discrete electrode 18, while a thickness of passivation layer 24 defines a width of capacitive gap 22. Discrete electrode 18 is electrically coupled to optically transparent electrode layer 26 through via 44 and continuous electrode 16 may be electrically coupled to an electrical contact.

The technique of FIG. 8 includes removing a portion of the passivation layer from the capacitive gap between the array of discrete electrodes and the continuous electrode (156), similar to step 108 of FIG. 4. FIG. 7I is a side view cross-sectional conceptual and schematic diagram illustrating an example removal of a portion of passivation layer 24 of FIG. 7H. The technique of FIG. 8 includes depositing the upconversion material into the capacitive gap (158), similar to step 110 of FIG. 4. FIG. 7J is a side view cross-sectional conceptual and schematic diagram illustrating an example deposition of upconversion material 20 in capacitive gap 22 between continuous electrode 16 and discrete electrode 18 of FIG. 7I.

In some examples, upconversion films having apertures with narrow capacitive gaps filled with upconversion materials may be fabricated using photolithography. Photolithography may be relatively simple, and may be suitable for forming upconversion films having larger capacitive gaps. When the gap is patterned by photolithography, its gap size is relatively wider than those gaps fabricated by atomic layer lithography. However, it can apply the DC or AC electric field for controlling the threshold field strength necessary for inducing the photon upconversion. FIGS. 9A-9G illustrate various intermediate and final configurations for forming upconversion films, such as upconversion film 10 of FIGS. 1A-1B and 2A-2E, using photolithography. FIG. 10 is a flow diagram illustrating example techniques for manufacturing an upconversion film for upconverting infrared light to visible light. The technique of FIG. 10 will be described with reference to FIGS. 9A-9G; however, it will be understood that the technique of FIG. 10 may be used to form other upconversion films or devices having other configurations, and that the upconversion films and devices of FIGS. 1A-1B and 2A-2E may be formed using other techniques.

The technique of FIG. 10 includes depositing a dielectric layer on a substrate (160), similar to step 140 of FIG. 8. FIG. 9A is a side view cross-sectional conceptual and schematic diagram illustrating an example deposition of dielectric layer 12 on optically transparent electrode layer 26. In some examples, the technique of FIG. 10 may include forming a hole in the dielectric layer to be filled with a conductive material as a via (162), similar to step 142 of FIG. 8. FIG. 9B is a side view cross-sectional conceptual and schematic diagram illustrating an example formation of a hole 80 for via 44 in dielectric layer 12 of FIG. 9A.

The technique of FIG. 10 includes depositing a conductive layer on the dielectric layer (164). FIG. 9C is a side view cross-section conceptual and schematic diagram illustrating an example deposition of conductive layer 17 on dielectric layer 12 of FIG. 9B. Conductive layer 17 may form a bulk material of both continuous electrode 16 and the array of discrete electrode 18, and may fill in hole 80 to form via 44.

The technique of FIG. 10 includes depositing a pattern layer on the conductive layer (156). FIG. 9D is a side view cross-sectional conceptual and schematic diagram illustrating an example deposition of a pattern layer 90 on conductive layer 17 of FIG. 9C. Pattern layer 90 may include a photoresist material applied to a surface of dielectric layer 12. Pattern layer 90 may correspond to continuous electrode 16 and discrete electrode 18, and may form gaps for an etchant to contact conductive layer 17.

The technique of FIG. 10 includes removing a portion of the conductive layer (158). FIG. 9E is a side view cross-sectional conceptual and schematic diagram illustrating an example removal of a portion of conductive layer 17 of FIG. 9D. Conductive material may be removed from conductive layer 17 to form capacitive gap 22 between discrete electrode 18 and continuous electrode 16, such as by ion-milling or REI etching. The technique of FIG. 10 includes removing the pattern layer from the continuous electrode and array of discrete electrodes. FIG. 9F is a side view cross-sectional conceptual and schematic diagram illustrating an example removal of pattern layer 90 from discrete electrode 18 and continuous electrode 16 of FIG. 9E.

In some examples, the technique of FIG. 10 may include coating the sidewalls of the capacitive gaps with an insulative material prior to depositing an upconversion material (not shown). For example, capacitive gap 22 may be coated with an insulation layer, such as a thin aluminum oxide layer, to reduce quenching of fluorescence. In some examples, an ALD process may be used to deposit the insulative layer, such as described with respect to passivation layer 24.

The technique of FIG. 10 may include depositing an upconversion material in the capacitive gap between the continuous electrode and the array of discrete electrodes (172), similar to step 110 of FIG. 4. FIG. 9G is a side view cross-sectional conceptual and schematic diagram illustrating an example deposition of upconversion material 20 in capacitive gap 22 between continuous electrode 16 and discrete electrode 18 of FIG. 9F.

Example 1: An upconversion film includes a substrate includes an optically transparent electrode layer includes an array of discrete electrodes; a continuous electrode; an array of discrete apertures between the array of discrete electrodes and the continuous electrode, wherein each discrete aperture of the array of discrete electrodes is defined by a capacitive gap; and an upconversion material in at least a portion of the capacitive gap of each discrete aperture, wherein the upconversion material is configured to upconvert infrared light to visible light.

Example 2: The upconversion film of example 1, wherein each capacitive gap is less than about 100 nanometers (nm).

Example 3: The upconversion film of any of examples 1 and 2, wherein each capacitive gap is less than about 20 nm.

Example 4: The upconversion film of any of examples 1 through 3, wherein the upconversion material is configured to upconvert infrared light having a resonant wavelength greater than the capacitive gap.

Example 5: The upconversion film of example 4, wherein the resonant wavelength is at least five times greater than the capacitive gap.

Example 6: The upconversion film of any of examples 1 through 5, wherein a sidewall of each discrete electrode of the array of discrete electrodes faces a sidewall of the continuous electrode.

Example 7: The upconversion film of any of examples 1 through 6, further comprising a passivation layer between the continuous electrode and the dielectric layer.

Example 8: The upconversion film of any of examples 1 through 7, wherein the dielectric layer includes an array of electrically conductive vias electrically coupling the array of discrete electrodes to the optically transparent electrode layer.

Example 9: The upconversion film of any of examples 1 through 8, wherein the upconversion material is configured to increase in upconversion efficiency in response to application of an electric field across the capacitive gap of the array of discrete apertures.

Example 10: The upconversion film of any of examples 1 through 9, wherein the upconversion material comprises a plurality of semiconductor nanocrystals.

Example 11: The upconversion film of any of examples 1 through 10, wherein the upconversion material comprises an organic light emitting polymer.

Example 12: The upconversion film of any of examples 1 through 11, wherein the upconversion material comprises a material having a perovskite structure.

Example 13: The upconversion film of any of examples 1 through 12, wherein the upconversion material is configured to upconvert long wave infrared light to visible light.

Example 14: The upconversion film of any of examples 1 through 13, wherein each discrete aperture of the array of discrete apertures is substantially polarization independent.

Example 15: The upconversion film of any of examples 1 through 14, further comprising a control circuit electrically coupled to the gap electrode layer and configured to generate an electric field across the capacitive gap of each discrete aperture.

Example 16: An infrared camera includes an imaging layer includes an array of discrete electrodes; a continuous electrode; an array of discrete apertures between the array of discrete electrodes and the continuous electrode, wherein each discrete aperture of the array of discrete electrodes is defined by a capacitive gap, and wherein each discrete aperture of the array of discrete apertures is aligned with a sensing element of the array of sensing elements; and an upconversion material in at least a portion of each capacitive gap, wherein the upconversion material is configured to upconvert infrared light to visible light.

Example 17: The infrared camera of example 16, wherein the array of sensing elements comprises an array of photosites, and wherein the imaging layer comprises at least one of a charge coupled device (CCD) sensor or a complementary metal-oxide semiconductor (CMOS) image sensor.

Example 18: The infrared camera of any of examples 16 and 17, wherein the array of sensing elements comprises an array of photodiodes, and wherein each photodiode of the array of photodiodes is aligned with a photodiode of the array of photodiodes.

Example 19: The infrared camera of any of examples 16 through 18, wherein each capacitive gap is less than about 100 nanometers (nm).

Example 20: The infrared camera of any of examples 16 through 19, wherein each capacitive gap is less than about 20 nm.

Example 21: The infrared camera of any of examples 16 through 20, wherein the upconversion material is configured to upconvert infrared light having a resonant wavelength greater than the capacitive gap.

Example 22: The infrared camera of example 21, wherein the resonant wavelength is at least five times greater than the capacitive gap.

Example 23: The infrared camera of any of examples 16 through 22, wherein a sidewall of each discrete electrode of the array of discrete electrodes faces a sidewall of the continuous electrode.

Example 24: The infrared camera of any of examples 16 through 23, wherein the gap electrode layer further comprises a passivation layer between the continuous electrode and the dielectric layer.

Example 25: The infrared camera of any of examples 16 through 24, wherein the dielectric layer includes an array of electrically conductive vias electrically coupling the array of discrete electrodes to the optically transparent electrode layer.

Example 26: The infrared camera of any of examples 16 through 25, wherein the upconversion material is configured to increase in upconversion efficiency in response to application of an electric field across the capacitive gap of the array of discrete apertures.

Example 27: The infrared camera of any of examples 16 through 26, wherein the upconversion material comprises a plurality of semiconductor nanocrystals.

Example 28: The infrared camera of any of examples 16 through 27, wherein the upconversion material comprises an organic light emitting polymer.

Example 29: The infrared camera of any of examples 16 through 28, wherein the upconversion material comprises a material having a perovskite structure.

Example 30: The infrared camera of any of examples 16 through 29, wherein the upconversion material is configured to upconvert long wave infrared light to visible light.

Example 31: The infrared camera of any of examples 16 through 30, wherein each discrete aperture of the array of discrete apertures is substantially polarization independent.

Example 32: The infrared camera of any of examples 16 through 31, wherein the imaging layer is configured to detect an intensity and polarization of the visible light.

Example 33: The infrared camera of any of examples 16 through 32, further includes generate an electric field across the capacitive gap of each discrete aperture; and measure an intensity of the visible light upconverted from the infrared light.

Example 34: An upconversion film includes a substrate; and a gap electrode layer overlaying the substrate, wherein the gap electrode layer comprises: an array of discrete electrodes; a continuous electrode; an array of discrete apertures between the array of discrete electrodes and the continuous electrode, wherein each discrete aperture of the array of discrete electrodes is defined by a capacitive gap, and wherein the capacitive gap of each discrete aperture is less than about 20 nanometers (nm); and an upconversion material in at least a portion of the capacitive gap of each discrete aperture, wherein the upconversion material is configured to upconvert infrared light to visible light.

Example 35: The upconversion film of example 34, wherein the upconversion material is configured to upconvert infrared light having a resonant wavelength greater than the capacitive gap.

Example 36: The upconversion film of example 35, wherein the resonant wavelength is at least five times greater than the capacitive gap.

Example 37: The upconversion film of any of examples 34 through 36, wherein a sidewall of each discrete electrode of the array of discrete electrodes faces a sidewall of the continuous electrode.

Example 38: The upconversion film of any of examples 34 through 37, further comprising a passivation layer between the continuous electrode and the substrate.

Example 39: The upconversion film of any of examples 34 through 38, wherein the substrate comprises a dielectric layer.

Example 40: The upconversion film of example 39, wherein the dielectric layer includes an array of electrically conductive vias configured to electrically couple the array of discrete electrodes to an electrical conductor on an underside of the dielectric layer.

Example 41: The upconversion film of any of examples 34 through 40, wherein the upconversion material is configured to increase in upconversion efficiency in response to application of an electric field across the capacitive gap of the array of discrete apertures.

Example 42: The upconversion film of any of examples 34 through 41, wherein the upconversion material comprises a plurality of semiconductor nanocrystals.

Example 43: The upconversion film of any of examples 34 through 42, wherein the upconversion material comprises an organic light emitting polymer.

Example 44: The upconversion film of any of examples 34 through 43, wherein the upconversion material comprises a material having a perovskite structure.

Example 45: The upconversion film of any of examples 34 through 44, wherein the upconversion material is configured to upconvert long wave infrared light to visible light.

Example 46: The upconversion film of any of examples 34 through 45, wherein each discrete aperture of the array of discrete apertures is substantially polarization independent.

Example 47: The upconversion film of any of examples 34 through 46, wherein the substrate further comprises an adhesive layer.

Example 48: The upconversion film of any of examples 34 through 47, further comprising a control circuit electrically coupled to the gap electrode layer and configured to generate an electric field across the capacitive gap of each discrete aperture.

Example 49: A method of manufacturing an upconversion film includes forming an array of discrete electrodes on a substrate; forming, using atomic layer deposition, a passivation layer on the array of discrete electrodes and an exposed portion of the substrate; forming a continuous electrode on the passivation layer to form an array of discrete apertures between the array of discrete electrodes and the continuous electrode, wherein each discrete aperture of the array of discrete electrodes is defined by a capacitive gap; removing at least a portion of the passivation layer in the capacitive gap of each discrete aperture; and depositing an upconversion material in at least a portion of the capacitive gap of each discrete aperture, wherein the upconversion material is configured to upconvert infrared light to visible light.

Example 50: The method of example 49, wherein each capacitive gap is less than about 20 nanometers (nm).

Example 51: The method of any of examples 49 and 50, wherein the substrate comprises a dielectric layer.

Example 52: The method of example 51, further comprising forming the dielectric layer.

Example 53: The method of example 52, wherein forming the dielectric layer further comprises depositing the dielectric layer on an optically transparent electrode layer, and wherein the optically transparent electrode layer comprises an optically transparent conductive material.

Example 54: The method of example 53, further comprising forming the optically transparent electrode layer on an imaging layer comprising an array of photodiodes, wherein each discrete aperture of the array of discrete apertures is aligned with a photodiode of the array of photodiodes.

Example 55: The method of any of any of examples 49 through 54, wherein forming the array of discrete electrodes on the dielectric layer further comprises: depositing a photoresist layer on the substrate, wherein the photoresist layer includes an array of openings; depositing a conductive material in the array of openings; and removing the photoresist layer.

Example 56: The method of example 55, wherein the conductive material is deposited using metal evaporation.

Example 57: The method of any of examples 55 and 56, wherein a sidewall of each discrete electrode of the array of discrete electrodes faces a sidewall of the continuous electrode.

Example 58: The method of any of examples 49 through 57, wherein forming the array of discrete electrodes further comprises depositing the array of discrete electrode using lift-off.

Example 59: The method of any of examples 49 through 58, wherein forming the continuous electrode on the passivation layer further comprises: depositing a conductive material on the passivation layer; and removing a portion of the conductive material and a portion of the passivation layer on the array of discrete electrodes to expose an outer surface of the array of discrete electrodes.

Example 60: The method of example 59, wherein the continuous electrode is formed using sputtering.

Example 61: The method of any of examples 59 and 60, wherein the portions of the conductive material and passivation layer are removed using a planarization technique.

Example 62: The method of any of examples 49 through 61, further includes forming an array of holes in the dielectric layer; and filling the array of holes with a conductive material to form an array of electrically conductive vias configured to electrically couple the array of discrete electrodes to an electrical conductor on an underside of the dielectric layer.

Example 63: The method of example 62, wherein forming the array of discrete electrodes includes filling the array of holes with the conductive material.

Example 64: The method of any of examples 49 through 63, wherein the upconversion material is configured to increase in conversion efficiency in response to application of an electric field across the capacitive gap of the array of discrete apertures.

Example 65: The method of any of examples 49 through 64, wherein the upconversion material comprises a plurality of semiconductor nanocrystals.

Example 66: The method of any of examples 49 through 65, wherein the upconversion material comprises an organic light emitting polymer.

Example 67: The method of any of examples 49 through 66, wherein the upconversion material comprises a material having a perovskite structure.

Example 68: The method of any of examples 49 through 67, wherein the upconversion material is configured to upconvert infrared light having a resonant wavelength greater than the capacitive gap.

Example 69: The method of example 68, wherein the resonant wavelength is at least five times greater than the capacitive gap.

Example 70: The method of any of examples 49 through 69, wherein the upconversion material is configured to upconvert long wave infrared light to visible light.

Example 71: The method of any of examples 49 through 70, wherein each discrete aperture of the array of discrete apertures is substantially polarization independent.

Example 72: A method for converting infrared light to visible light includes applying, by control circuitry, a voltage to a gap electrode layer overlying a substrate, wherein the gap electrode layer comprises: an array of discrete electrodes; a continuous electrode; an array of discrete apertures between the array of discrete electrodes and the continuous electrode, wherein each discrete aperture of the array of discrete electrodes is defined by a capacitive gap; and an upconversion material in at least a portion of each capacitive gap, wherein the upconversion material is configured to upconvert infrared light to visible light, wherein applying the voltage to the gap electrode layer induces the upconversion material to upconvert the infrared light to the visible light.

Example 73: The method of example 72, further includes receiving, by the control circuitry and from an imaging layer underlying the substrate, a signal representing an intensity of the visible light, wherein the imaging layer comprises an array of sensing elements configured to detect the intensity of a portion of the visible light, and wherein each discrete aperture of the array of discrete apertures is aligned with a sensing element of the array of sensing elements.

Example 74: The method of any of examples 72 and 73, wherein the infrared light is long wave infrared light.

Example 75: The method of example 74, wherein the long wave infrared light has a wavelength from about 8 to about 15 micrometers (μm).

Various examples of the disclosure have been described. Any combination of the described systems, operations, or functions is contemplated. These and other examples are within the scope of the following claims.

1. An upconversion film, comprising:
a substrate comprising:
an optically transparent electrode layer comprising an optically transparent conductive material; and
a dielectric layer overlaying the optically transparent electrode layer; and
a gap electrode layer overlying the dielectric layer, wherein the gap electrode layer comprises:
an array of discrete electrodes;
a continuous electrode;
an array of discrete apertures between the array of discrete electrodes and the continuous electrode, wherein each discrete aperture of the array of discrete electrodes is defined by a capacitive gap; and
an upconversion material in at least a portion of the capacitive gap of each discrete aperture, wherein the upconversion material is configured to upconvert infrared light to visible light.

2. The upconversion film of claim 1, wherein each capacitive gap is less than about 100 nanometers (nm).

3. The upconversion film of claim 1, wherein each capacitive gap is less than about 20 nm.

4. The upconversion film of claim 1, wherein the upconversion material is configured to upconvert infrared light having a resonant wavelength greater than the capacitive gap.

5. The upconversion film of claim 4, wherein the resonant wavelength is at least five times greater than the capacitive gap.

6. The upconversion film of claim 1, wherein a sidewall of each discrete electrode of the array of discrete electrodes faces a sidewall of the continuous electrode.

7. The upconversion film of claim 1, further comprising a passivation layer between the continuous electrode and the dielectric layer.

8. The upconversion film of claim 1, wherein the dielectric layer includes an array of electrically conductive vias electrically coupling the array of discrete electrodes to the optically transparent electrode layer.

9. The upconversion film of claim 1, wherein the upconversion material is configured to increase in upconversion efficiency in response to application of an electric field across the capacitive gap of the array of discrete apertures.

10. The upconversion film of claim 1, wherein the upconversion material comprises at least one of a plurality of semiconductor nanocrystals, an organic light emitting polymer, or a material having a perovskite structure.

11. (canceled)

12. (canceled)

13. The upconversion film of claim 1, wherein the upconversion material is configured to upconvert long wave infrared light to visible light.

14. The upconversion film of claim 1, wherein each discrete aperture of the array of discrete apertures is substantially polarization independent.

15. The upconversion film of claim 1, further comprising a control circuit electrically coupled to the gap electrode layer and configured to generate an electric field across the capacitive gap of each discrete aperture.

16. An infrared camera, comprising:
an imaging layer comprising an array of sensing elements configured to detect an intensity of visible light;
an optically transparent electrode layer overlying the imaging layer, the optically transparent electrode layer comprising an optically transparent conductive material;
a dielectric layer overlying the optically transparent electrode layer;
a gap electrode layer overlying the dielectric layer, wherein the gap electrode layer comprises:
an array of discrete electrodes;
a continuous electrode;
an array of discrete apertures between the array of discrete electrodes and the continuous electrode, wherein each discrete aperture of the array of discrete electrodes is defined by a capacitive gap, and wherein each discrete aperture of the array of discrete apertures is aligned with a sensing element of the array of sensing elements; and
an upconversion material in at least a portion of each capacitive gap, wherein the upconversion material is configured to upconvert infrared light to visible light.

17. The infrared camera of claim 16,
wherein the array of sensing elements comprises an array of photosites, and
wherein the imaging layer comprises at least one of a charge coupled device (CCD) sensor or a complementary metal-oxide semiconductor (CMOS) image sensor.

18. The infrared camera of claim 16,
wherein the array of sensing elements comprises an array of photodiodes, and
wherein each photodiode of the array of photodiodes is aligned with a photodiode of the array of photodiodes.

19-31. (canceled)

32. The infrared camera of claim 16, wherein the imaging layer is configured to detect an intensity and polarization of the visible light.

33. The infrared camera of claim 16, further comprising a control circuit electrically coupled to the gap electrode layer and the imaging layer and configured to:
generate an electric field across the capacitive gap of each discrete aperture; and measure an intensity of the visible light upconverted from the infrared light.

34. An upconversion film, comprising:
a substrate; and
a gap electrode layer overlaying the substrate, wherein the gap electrode layer comprises:
an array of discrete electrodes;
a continuous electrode;
an array of discrete apertures between the array of discrete electrodes and the continuous electrode, wherein each discrete aperture of the array of discrete electrodes is defined by a capacitive gap, and wherein the capacitive gap of each discrete aperture is less than about 20 nanometers (nm); and
an upconversion material in at least a portion of the capacitive gap of each discrete aperture, wherein the upconversion material is configured to upconvert infrared light to visible light.

35. The upconversion film of claim 34, wherein the upconversion material is configured to upconvert infrared light having a resonant wavelength greater than the capacitive gap.

36. The upconversion film of claim 35, wherein the resonant wavelength is at least five times greater than the capacitive gap.

37. The upconversion film of claim 34, wherein a sidewall of each discrete electrode of the array of discrete electrodes faces a sidewall of the continuous electrode.

38. The upconversion film of claim 34, further comprising a passivation layer between the continuous electrode and the substrate.

39. (canceled)

40. (canceled)

41. The upconversion film of claim 34, wherein the upconversion material is configured to increase in upconversion efficiency in response to application of an electric field across the capacitive gap of the array of discrete apertures.

42. The upconversion film of claim 34, wherein the upconversion material comprises at least one of a plurality of semiconductor nanocrystals, an organic light emitting polymer, or a material having a perovskite structure.

43. (canceled)

44. (canceled)

45. The upconversion film of claim 34, wherein the upconversion material is configured to upconvert long wave infrared light to visible light.

46. The upconversion film of claim 34, wherein each discrete aperture of the array of discrete apertures is substantially polarization independent.

47. The upconversion film of claim 34, wherein the substrate further comprises an adhesive layer.

48. The upconversion film of claim 34, further comprising a control circuit electrically coupled to the gap electrode layer and configured to generate an electric field across the capacitive gap of each discrete aperture.

49-75. (canceled)
